(19) United States
(12) Patent Application Publication
(10) Pub. No.: US 2015/0059992 A1
(43) Pub. Date: Mar. 5, 2015

(54) Damper unit for Roller Blind

(71) Applicant: Tai-Ping LIU, Taichung City (TW)

(72) Inventor: Tai-Ping LIU, Taichung City (TW)

(21) Appl. No.: 14/013,553

(22) Filed: Aug. 29, 2013

(51) Int. Cl. E06B 9/56; E06B 9/42

(52) U.S. Cl. CPC E06B 9/56; E06B 9/42
USPC 160/313

(57) ABSTRACT

A roller blind includes a roller, a web wound on the roller, and a damper unit for damping the rotation of the roller. The damper unit includes a cylinder, an axle and a damper. The cylinder is inserted in the roller so that they are rotatable together. The axle is inserted in the cylinder so that the cylinder is rotatable on the axle. The damper is provided between the cylinder and the axle to damp the rotation or the cylinder on the axle.

### BACKGROUND OF INVENTION

1. Field of Invention

The present invention relates to a roller blind and, more particularly, to a damper unit for a roller blind.

2. Related Prior Art

As disclosed in Taiwanese Patent Publication Nos. 174404 and 481217, a conventional roller blind includes a web wound on a roller supported on a frame secured to a wall. Generally, a weight in the form of a rod, tube or blade is tied to an edge of the web while an opposite edge of the web is tied to the roller. The roller is rotated in a direction to release the web from the roller. The web is spread neatly by the weight. The roller is rotated in an opposite direction to withdrawn the web onto the roller. It requires an adequate force to withdrawn the web onto the roller because of the weight. However, an excessive force is often used to withdraw the web onto the roller because an insufficient does not withdraw the web onto the roller at all. Such an excessive force causes the weight to bump the frame and make loud noise, and this is annoying and dangerous.

Therefore, the present invention is intended to obviate or at least alleviate the problems encountered in prior art.

### SUMMARY OF INVENTION

It is the primary objective of the present invention to provide a roller blind which is operable nicely and quietly.

To achieve the foregoing objective, the roller blind includes a roller, a web wound on the roller, and a damper unit for damping the rotation of the roller. The damper unit includes a cylinder, an axle and a damper. The cylinder is inserted in the roller so that they are rotatable together. The axle is inserted in the cylinder so that the cylinder is rotatable on the axle. The damper is provided between the cylinder and the axle to damp the rotation or the cylinder on the axle.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a roller blind according to the first embodiment of the present invention;

FIG. 2 is an exploded view of the roller blind shown in FIG. 1;

FIG. 3 is a partial, perspective view of a cylinder of the roller blind shown in FIG. 1;

FIG. 4 is a cross-sectional view of the roller blind shown in FIG. 1;

FIG. 5 is another cross-sectional view of the roller blind taken along a line A-A shown in FIG. 4;

FIG. 6 is a cross-sectional view of the roller blind in another position than shown in FIG. 5;

FIG. 7 is a cross-sectional view of the roller blind in another position than shown in FIG. 4;

FIG. 8 is a cross-sectional view of the roller blind in another position than shown in FIG. 7;

FIG. 9 is a cross-sectional view of a roller blind according to the second embodiment of the present invention;

FIG. 10 is a cross-sectional view of the roller blind in another position than shown in FIG. 9;

FIG. 11 is an exploded view of a roller blind according to the third embodiment of the present invention;

FIG. 12 is a perspective view of a disc of the roller blind shown in FIG. 11; and

FIG. 13 is a cross-sectional view of the roller blind shown in FIG. 11.

### DETAILED DESCRIPTION OF PREFERRED EMBODIMENT

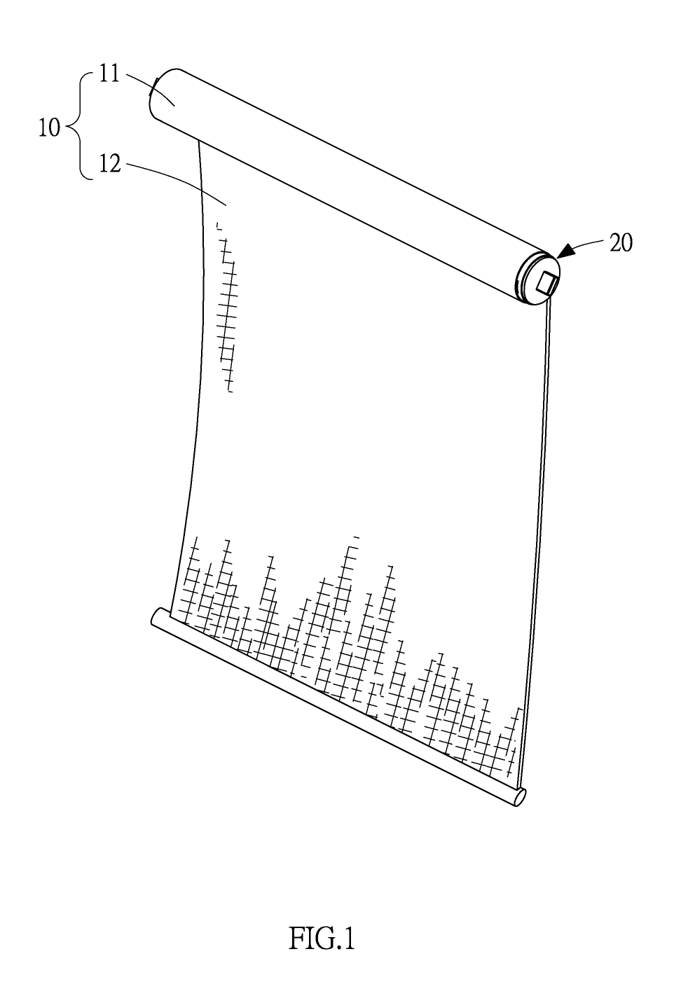

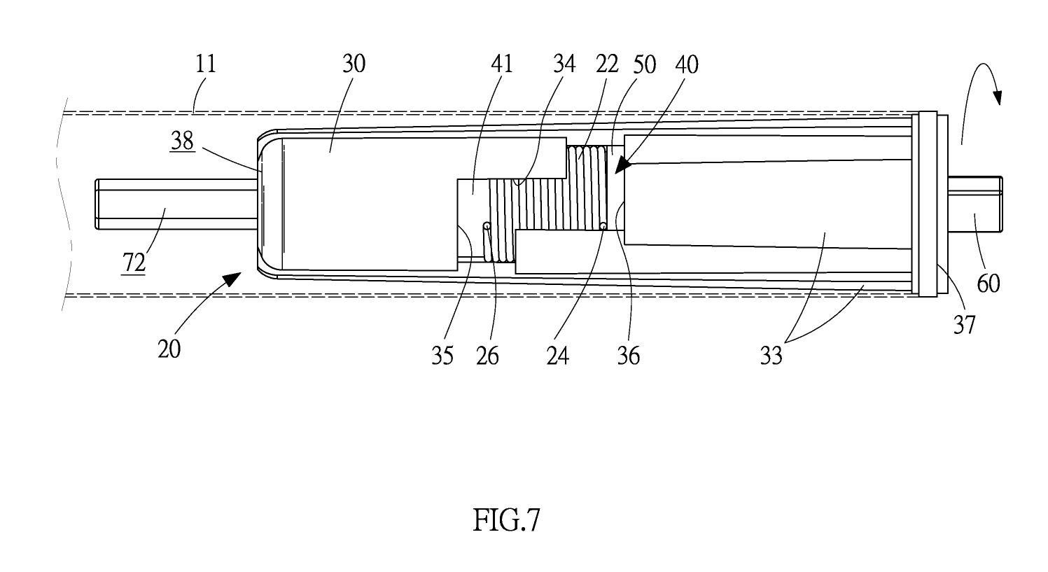

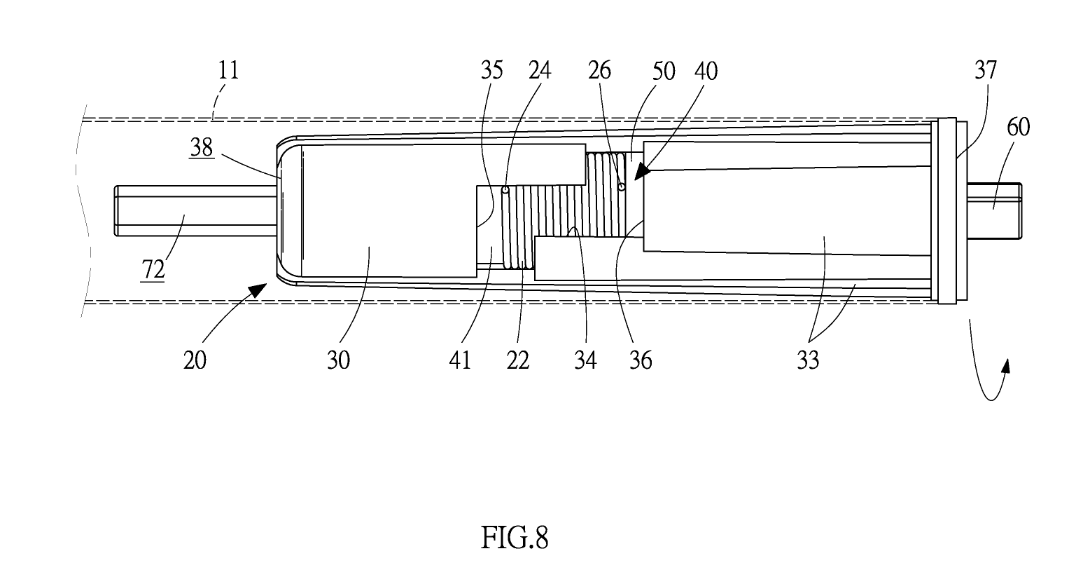

Referring to FIGS. 1 through 8, there is a roller blind 10 according to a first embodiment of the present invention. The roller blind 10 includes web 12 wound on a roller 11 supported on a frame (not shown) secured to a wall (not shown). An edge of the web 12 is connected to the roller 11 while a weight (not numbered) in the form of a rod, tube or blade is tied to an opposite edge of the web 12. Referring to FIG. 7, the roller 11 is rotated in a first direction to release the web 12 from the roller 11. The web 12 is spread neatly by the weight. Referring to FIG. 8, the roller 11 is rotated in a second direction to withdrawn the web 12 onto the roller 11. An excessive force is often used to withdraw the web 12 onto the roller 11 since an insufficient does not withdraw the web onto the roller at all. The roller blind 10 further includes a damper unit 20 for damping the withdrawal of the web 12 onto the roller 11 to prevent such an excessive force from causing the weight to bump the frame and make loud noise.

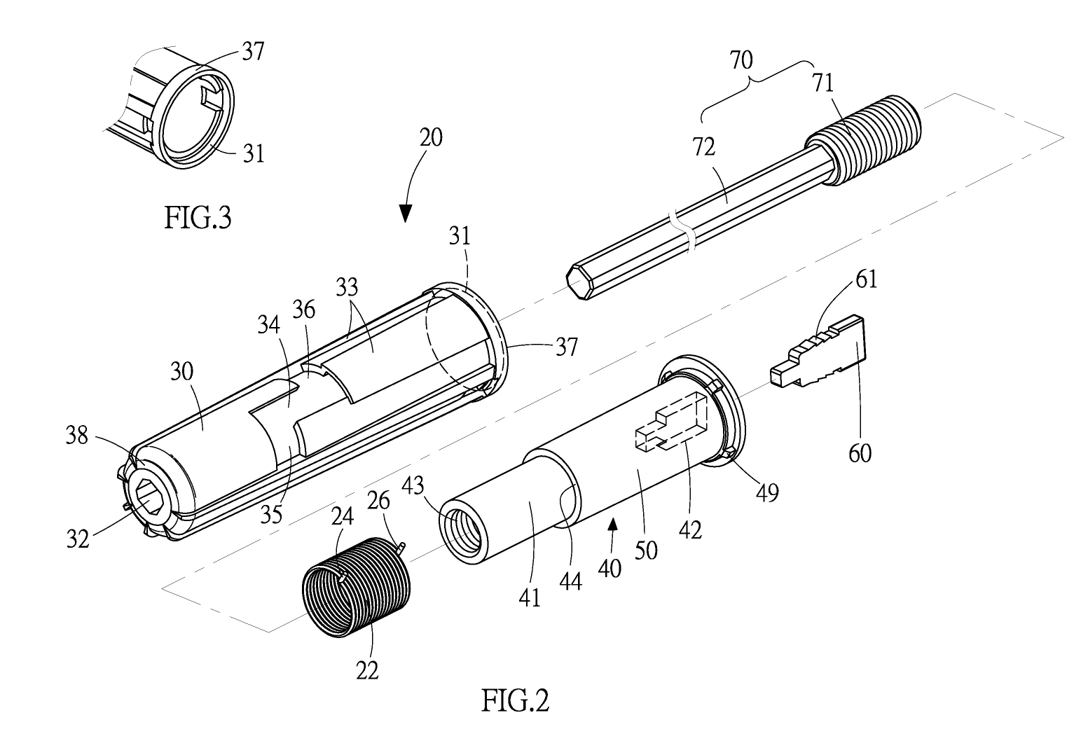

Referring to FIGS. 2 and 3, the damper unit 20 includes a damper 22, a cylinder 30, an axle 40, a lock 60 and a rod 70. The damper 22 is a helical spring that includes two radial ends 24 and 26 extending perpendicular to an axis about which the helical spring extends.

The cylinder 30 includes two ends 37 and 38, a circular aperture 31 in the end 37, a polygonal aperture 32 in the end 38, three slots 34, 35 and 36 in the periphery, and ribs 33 on the periphery. The end 37 is made with an external diameter larger than that of the end 38. The slot 34 extends longitudinally while the slots 35 and 36 extend transversely. The slot 34 extends to the slot 35 from the slot 36. Thus, the slots 34, 35 and 36 together become a Z-shaped opening

The rod 70 is formed with a polygonal section 72 and a threaded section 71. The polygonal section 72 is made corresponding to the polygonal aperture 32.

The axle 40 includes two sections 41 and 50, a screw hole 43 in the section 41, and a flat cavity 42 in the section 50, and blocks 49 on an external side of the section 50. The section 50 is made with an external diameter larger than that of the section 41, thus forming a shoulder 44 between the sections 41 and 50. The screw hole 43 is made corresponding to the threaded section 71.

The lock 60 is substantially made corresponding to the flat cavity 42. However, the lock 60 includes two groups of ratchets 61. Each group of ratchets 61 is arranged along a corresponding edge of the lock 60.

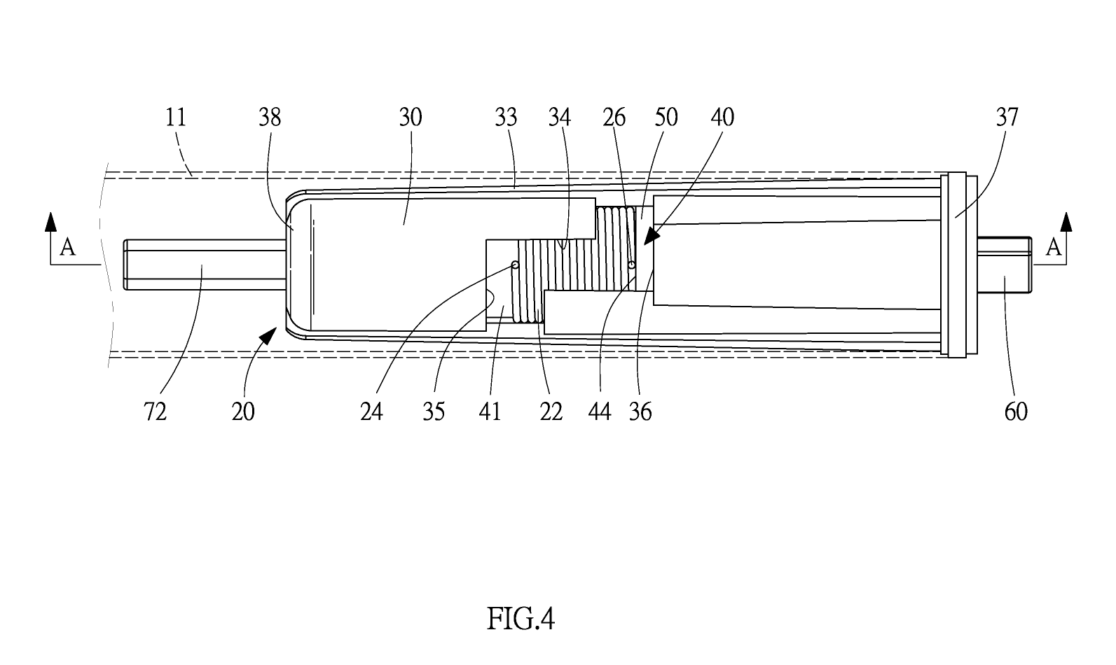

Referring to FIG. 4, a section of the lock 60 is inserted in the flat cavity 42 of the axle 40 while an opposite section of the lock 60 is secured to the frame of the roller blind 10. Thus, the axle 40 and the lock 60 are not rotatable relative to the frame of the roller blind 10. The groups of ratchets 61 enable easy insertion of the lock 60 into the flat cavity 42. However, in an attempt to pull the lock 60 from the flat cavity 42, the groups of ratchets 61 bite the wall of the cavity 42 and keep the lock 60 in the flat cavity 42.

The section 41 of the axle 40 is inserted in the damper 22. The damper 22 is allowed to rotate on the section 41 of the axle 40.

The threaded section 71 of the rod 70 is inserted in the screw hole 43 of the axle 40. Thus, the rotation of the rod 70 relative to the axle 40 causes rectilinear movement of the rod 70 relative to the axle 40.

The polygonal section 72 of the rod 70 is inserted in the polygonal aperture 32 of the cylinder 30 while the axle 40 and the damper 22 are placed in the cylinder 30. The radial ends 24 and 26 of the damper 22 are inserted in the slots 35 and 36, respectively. The blocks 49 are placed in the circular aperture 31. The cylinder 30 is allowed to smoothly rotate on the axle 40 due to a small total area of contact of the wall of the circular aperture 31 with the blocks 49. The cylinder 30 is fit in the roller 11 so that they are rotatable together.

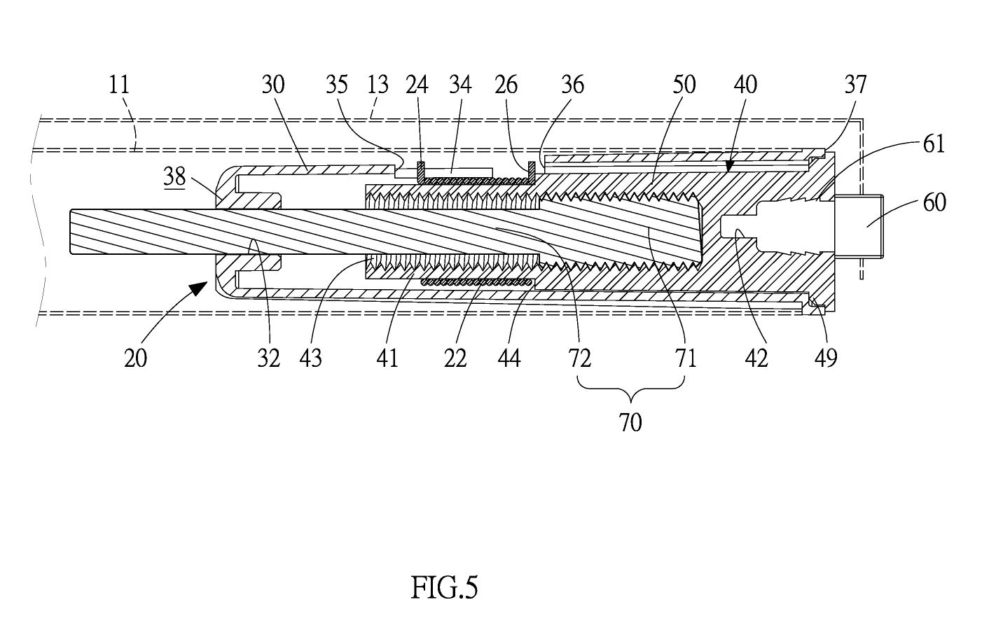

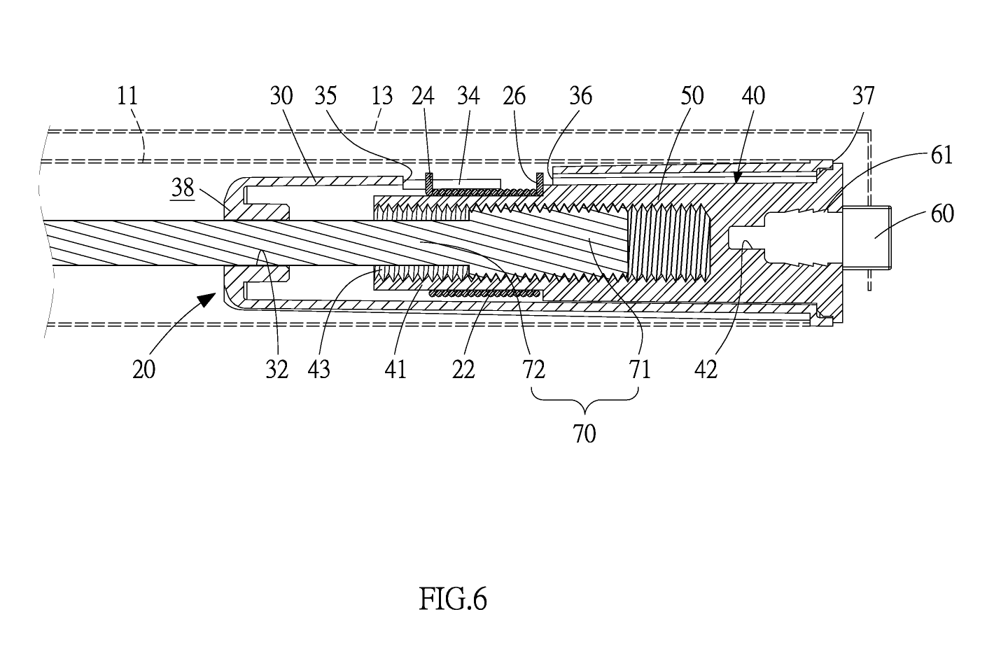

Referring to FIG. 7, the roller 11 is rotated in the first direction to release the web 12 from the roller 11. The cylinder 30 and the rod 70 are rotated in the first direction relative to the axle 40. The rotation of the rod 70 in the first direction causes rectilinear movement of the rod 70 into a position shown in FIG. 6 from a position shown in FIG. 5 because of the insertion of the threaded section 71 of the rod 70 in the screw hole 43 of the axle 40.

The radial end 26 of the damper 22 is pressed by the cylinder 30 so that the damper 22 is rotated on the axle 40. The friction between the damper 22 and the axle 40 damps the rotation of the cylinder 30 and the roller 11.

Referring to FIG. 8, the roller 11 is rotated in the second direction to withdraw the web 12 onto the roller 11. Accordingly, the cylinder 30 and the rod 70 are rotated in the second direction relative to the axle 40. The rotation of the rod 70 in the second direction causes rectilinear movement of the rod 70 into the position shown in FIG. 5 from the position shown in FIG. 6 due to the insertion of the threaded section 71 of the rod 70 in the screw hole 43 of the axle 40.

The radial end 24 of the damper 22 is pressed by the cylinder 30 so that the damper 22 is rotated on the axle 40. The friction between the damper 22 and the axle 40 damps the rotation of the cylinder 30 and the roller 11.

The threaded section 71 reaches a closed end of the screw hole 43 to avoid further rotation of the rod 70 relative to the axle 40 in the second direction. The extent to which the web 12 can be withdrawn onto the roller 11 is adjustable by changing the depth of the threaded section 71 in the screw hole 43 when the web 12 is substantially completely released from the roller 11. The web 12 can be withdrawn onto the roller 11 to a relatively small extent if the threaded section 71 is relatively deep in the screw hole 43 when the web 12 is substantially completely released from the roller 11. The web 12 can be withdrawn onto the roller 11 to a relatively large extent if the threaded section 71 is relatively shallow in the screw hole 43 when the web 12 is substantially completely released from the roller 11.

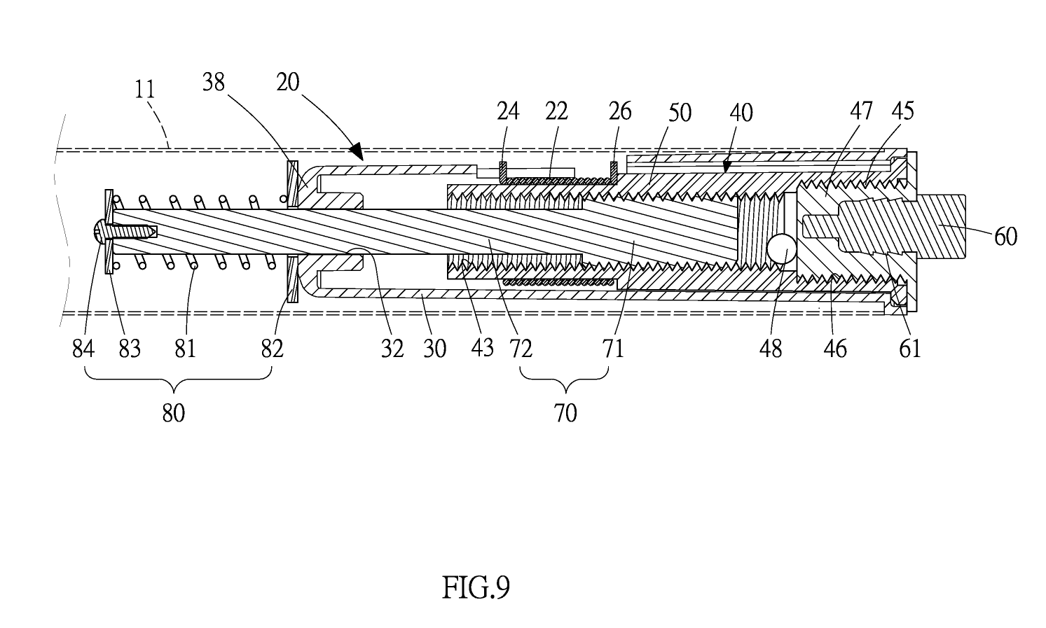

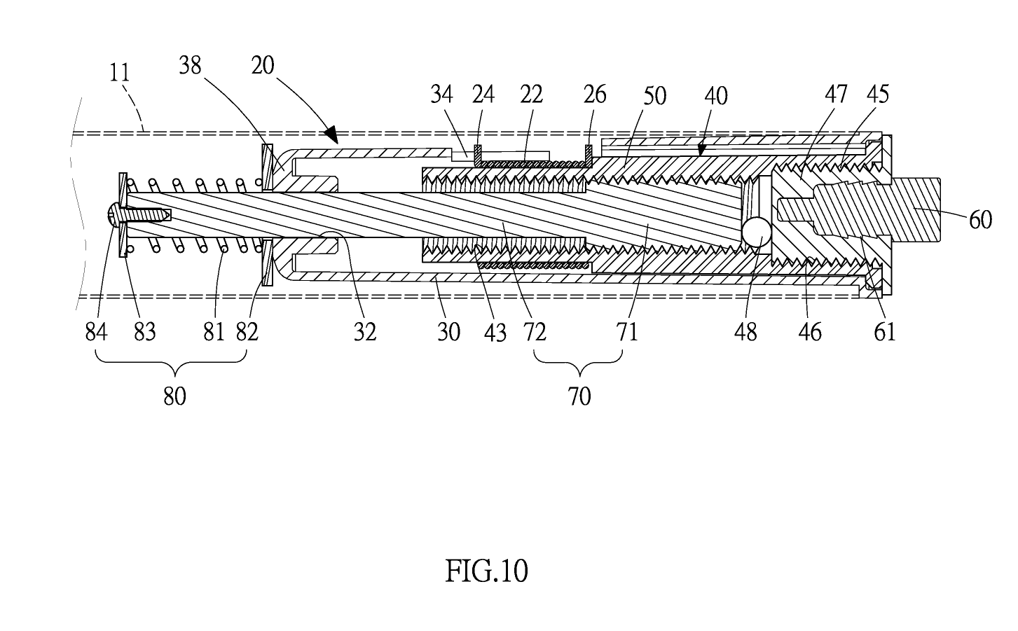

Referring to FIGS. 9 and 10, there is a roller blind according to a second embodiment of the present invention. The second embodiment is like the first embodiment except four things. At first, the axle 40 includes a screw hole 46 instead of the flat cavity 42. Secondly, there is additionally a plug 47. The plug 47 includes a threaded section 45 inserted in the screw hole 46. The flat cavity 42 is made in the plug 47 instead of the axle 40. Thirdly, there is a ball 48 to keep the threaded section 71 from the plug 47 and hence avoid deadlock of the threaded section 71 to the plug 47. Fourthly, there is an auxiliary damper 80. The auxiliary damper 80 includes a spring 81, a ring 82, a washer 83 and a screw 84. The ring 82 is placed on the polygonal section 72 of the rod 70 and against the end 38 of the cylinder 30. The screw 84 is used to secure the washer 83 to the tip of the polygonal section 72. The spring 81 is compressed between the ring 82 and the washer 83. Thus, the threaded section 71 of the rod 70 is tighter in the screw hole 43 according to the second embodiment than the first embodiment, and the damping is better according to the second embodiment than the first embodiment.

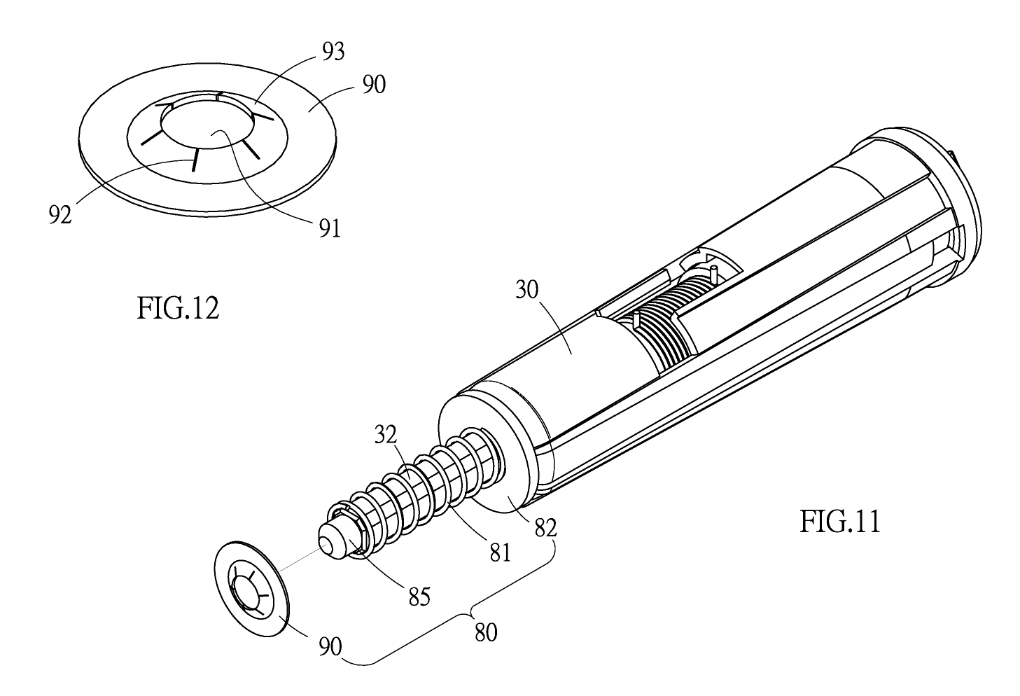

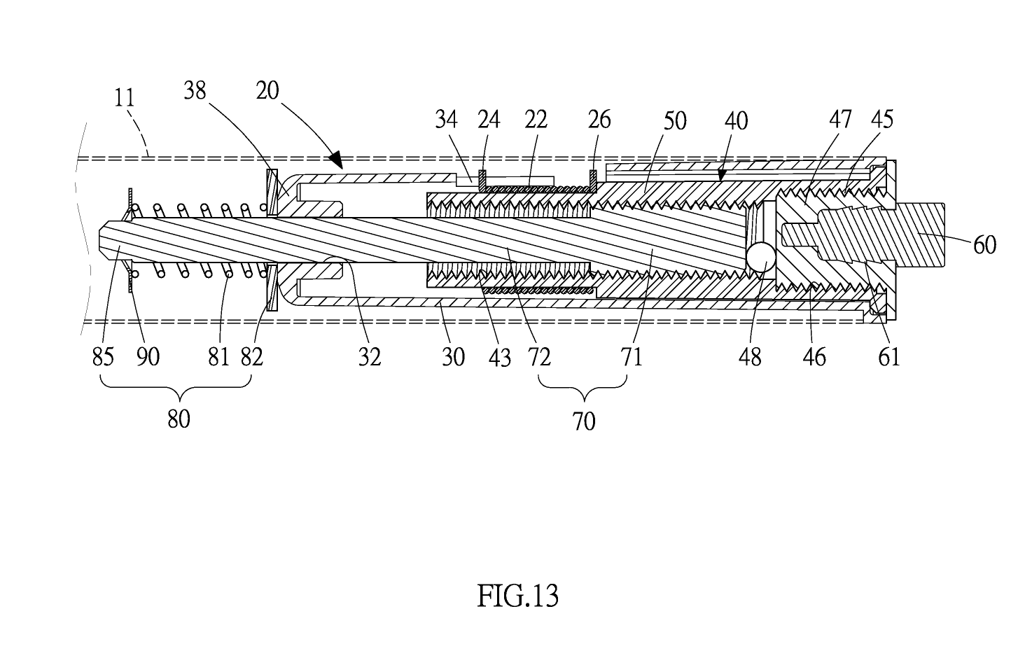

Referring to FIGS. 11 through 13, there is a roller blind according to a third embodiment of the present invention. The third embodiment is like the second embodiment except several things. At first, a clip 90 is used instead of the washer 83 and the screw 84. The clip 90 includes an aperture 91 made therein axially, a conical frustum 93 formed around the aperture 91, and slits 92 made in the conical frustum 93 in a radial manner. Secondly, the rod 70 includes a circular section 85 extending from the polygonal section 72. The aperture 91 is made with a diameter smaller than that of the circular section 85. The aperture 91 and the slits 92 are enlarged as the clip 90 is forced onto the circular section 85 in a direction. The clip 90 tends to close and lock itself onto the circular section 85.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A roller blind including a roller, a web wound on the roller, and a damper unit including a cylinder inserted in the roller so that they are rotatable together, an axle inserted in the cylinder so that the cylinder is rotatable on the axle, and a first damper placed between the cylinder and the axle to damp the rotation or the cylinder on the axle.

2. The roller blind according to claim 1, wherein the damper is a helical spring.

3. The roller blind according to claim 2, wherein the helical spring includes two radial ends each for contact with a corresponding portion of the cylinder as the cylinder is rotated on the axle in a corresponding direction.

4. The roller blind according to claim 3, wherein the cylinder includes a slot for receiving the radial ends of the helical spring, wherein each of the radial ends is in contact with a corresponding portion of the cylinder by the slot as the cylinder is rotated on the axle in a corresponding direction.

5. The roller blind according to claim 4, wherein the damper unit includes a lock for locking the axle.

6. The roller blind according to claim 5, wherein the lock is a flat element, wherein the axle includes a flat cavity for receiving the lock.

7. The roller blind according to claim 6, wherein the lock includes ratchets for biting a wall of the flat cavity in an attempt to pull the lock from the flat cavity.

8. The roller blind according to claim 5, wherein the lock is a flat element, wherein the damper unit includes a plug formed with a flat cavity for receiving the lock and connected to the axle.

9. The roller blind according to claim 8, wherein the lock includes ratchets for biting a wall of the flat cavity in an attempt to pull the lock from the flat cavity.

10. The roller blind according to claim 8, wherein the plug is formed with a threaded section, wherein the axle includes a screw hole for receiving the threaded section of the plug.

11. The roller blind according to claim 1, wherein the cylinder includes ribs formed thereon.

12. The roller blind according to claim 1, wherein the damper unit includes a rod formed with threaded section and a polygonal section, wherein the axle includes a screw hole for receiving the threaded section of the rod, wherein the cylinder includes a polygonal aperture for receiving the polygonal section of the rod so that the rotation of the cylinder on the axle causes rectilinear movement of the rod relative to the axle.

13. The roller blind according to claim 12, wherein excessive withdrawal of the web onto the roller is avoided as excessive rotation of the cylinder on the axle is stopped when the threaded section of the rod reaches a closed end of the screw hole.

14. The roller blind according to claim 13, wherein the damper unit includes an auxiliary damper for damping the rotation of the threaded section of the rod in the screw hole.

15. The roller blind according to claim 14, wherein the auxiliary damper includes a spring compressed between a portion of the polygonal section of the rod and an end of the cylinder.

16. The roller blind according to claim 15, wherein the auxiliary damper includes a ring placed between the spring and the cylinder.

17. The roller blind according to claim 16, wherein the auxiliary damper includes a washer secured to the polygonal section of the rod, wherein the spring is compressed between the ring and the washer.

18. The roller blind according to claim 17, wherein the auxiliary damper includes a screw for securing the washer to the polygonal section of the rod.

19. The roller blind according to claim 17, wherein the auxiliary damper includes a clip secured to the polygonal section of the rod, wherein the spring is compressed between the ring and the clip.

20. The roller blind according to claim 12, wherein the damper unit includes a ball placed between the rod and the axle.
